(19) United States
(12) Patent Application Publication
(10) Pub. No.: US 2013/0084071 A1
(43) Pub. Date: Apr. 4, 2013

(54) Manual ROADM front panel configuration

(71) Applicants: Bogdan Chomycz, (US); Michael Tate, (US)

(72) Inventors: Bogdan Chomycz, (US); Michael Tate, (US)

(21) Appl. No.: 13/249,768

(22) Filed: Sep. 30, 2011

(51) Int. Cl. H04J 14/02

(52) U.S. Cl. 398/79

(57) ABSTRACT

With Reconfigurable Optical Add Drop Modules (ROADMs) gaining popularity in the fiber optic market, many network designers are seeing the benefits of this technology. But the industry standard has been to make ROADMs automatically configurable, which adds considerably to the cost. Significant savings can be achieved by creating a manual ROADM for locations that do not require frequent configuration changes. This is achieved using a unique front panel configuration of a simple Optical Add Drop Module (OADM) system.

### FIELD OF THE INVENTION

This invention is a unique way of designing back to back Wavelength Division Multiplexers (WDMs) to form a manual Reconfigurable Optical Add Drop Module (ROADM) with a unique configuration of the front panel using loop plugs or similar type connectors.

### BACKGROUND OF THE INVENTION

Optical Add Drop Modules (OADMs) have been a staple of fiber optic communication for a long time, and allow for a fixed number of channels on a multi-channel system to be dropped at a location, while the rest of the channels pass through unaltered. This can be done with a number of methods, including putting two, dual fiber, Wavelength Division Multiplexers (WDMs) back to back and directly connecting channels that are desired to be passed through together.

Reconfigurable OADMs (ROADMs) have been widely deployed in both long haul and metro networks for some time as well. Their advantage is that they allow network engineers to build out capacity for their current needs, while keeping their network flexible to grow and handle any unforeseen demands that crop up in the future.

Traditionally, ROADMs have been remotely controllable both in channel switching, and in power adjustment. It also traditionally uses Dense Wave Division Multiplexing (DWDM) and a minimum of 32 channels per ROADM. This has kept the costs high for this equipment. For users who need the flexibility of a ROADM, but do not anticipate frequent changes to their network, a more cost effective, but just as flexible alternative is desirable.

What is needed is a manual ROADM that uses the principles of back to back WDMs used as an OADM with connectors positioned so that reconfiguring this system is easily done by somebody at the unit.

### BRIEF DESCRIPTION OF THE DRAWINGS

Examples of the present invention are illustrated in the accompanying drawings. The accompanying drawings, however, do not limit the scope of the present invention.

FIG. 1 shows the main layout of the manual ROADM front panel.

FIG. 2 shows up close one of the channel ports

FIG. 3 is a block diagram of the internal workings of the Manual ROADM

### DETAILED DESCRIPTION OF THE INVENTION

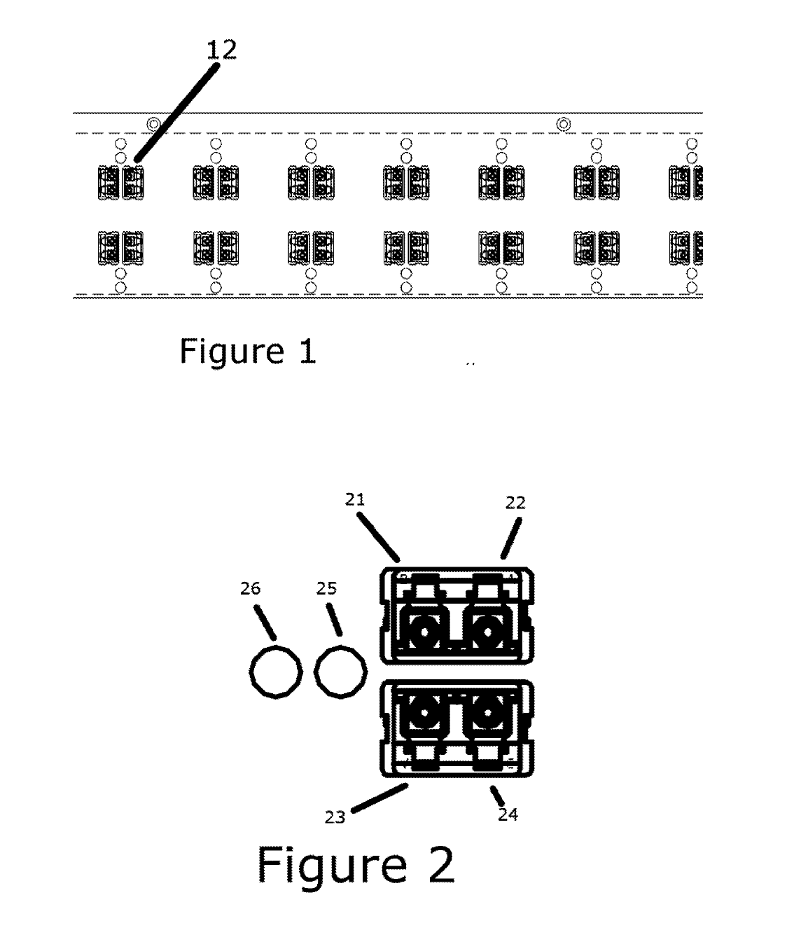

The manual ROADM faceplate is shown in FIG. 1. It will contain two common input and output ports. These will be signified by the “West” input and output port (10) and the “East” input and output port (11). On both (10) and (11), monitor ports can be inserted to allow for channel power monitoring and levelling. The optional “West” monitor port is signified by (13) and the optional “East” monitor port is signified by (14). Once inside the manual ROADM, these common signals will be split out by the WDM and broken up into individual channels where they will be accessible on the face plate at (12).

FIG. 2 shows a close up of one of channel port (12). It will contain an “East” input (21) and a “West” output (22) linked by a dual fiber connector. This is done so that if the network operator wants the “East” to “West” optical path on this channel to pass through this Manual ROADM, a simple loop plug is inserted into the connector. Similarly there will be a mirroring dual port that contains a “West” input (23) and a “East” output (24). Again this is combined into a dual connector to allow for the network operator to either pass the “West” to “East” optical path on this channel or drop the path on this channel. Additionally, there will be an optional manual Variable Optical Attenuator (VOA) (25) that will be able to attenuate the power going into the Manual ROADM at (22). This will allow the network operator to adjust the channel powers manually on the individual channels. This can be monitored with Monitor port (13). Similarly for the east side, there is a manual VOA (26) that will attenuate the power going into the Manual ROADM at (24). This can be monitored using monitor port (14).

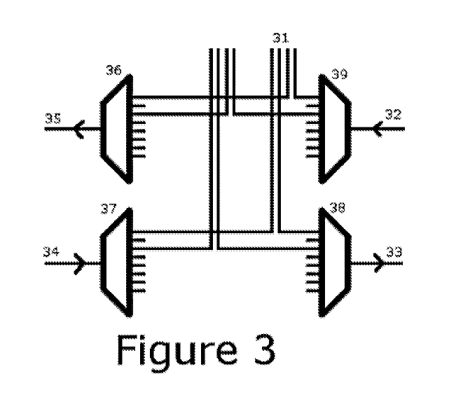

FIG. 3 shows a fiber block diagram of the internal fiber connections of the internal WDMs of the Manual ROADM. The inputs (21, 22, 23, and 24) in FIG. 2 are shown grouped together as (31) in FIG. 3. The “West” common input (32) and common output (33) are represented as (10) in FIG. 1 and the “East” common input (34) and common output (35) are represented as (11) in FIG. 1. The back to back WDMs are (36, 37, 38, and 39). These WDMs can be either Dense Wave Division Multiplexers (DWDMs) or Coarse Wave Division Multiplexers (CWDMs.)

The use of these DWDMs or CWDMs, loop plugs, and the lack of automatic switching allows this device to accommodate any number of channel counts from as few as 2 to as many channels as can be fit into the fiber spectrum, as well as gives the network operator control over how many channels drop at a location and pass through at a location. It also has the option to allow the channel power levels to be modified by the network operator.

This invention has described what is called a two degree ROADM, where there are two channel aggregate fiber trunks, labelled in this case “East” and “West”. Each trunk consists of one or two fibers that consist of the total aggregate channels of the internal WDMs of the Manual ROADM. But the scope of this invention is not limited to two degrees, and can be applied to any number of degrees as well as any other arbitrary labelling of the trunks. In addition, the scope of this invention is not limited to CWDMs or DWDMs, but any type of wave division multiplexing available now or in the future.

What is claimed is:

1. Wavelength Division Multiplexers (WDMs), that can be either Coarse (CWDM) or Dense (DWDM), are placed together in a configuration that has all of their channel's fiber connections going to a front panel, where the channels fiber connections from all four WDMs are placed next to each other for reconfiguration.

2. The invention in claim 1 wherein one of the WDM mux/demux fiber pairs are labeled “West” and the other fiber pair is labeled “East.”

3. The invention in claim 2 wherein the individual fiber output channels of the “West” WDMs are paired, using a standard dual connector, with the individual fiber input channels of the “East” WDMs; as well as the individual fiber input channels of the “West” WDMs are paired, using a standard dual connector, with the individual fiber output channels of the “East” WDMs.

4. The invention in claim 1 wherein all the channel outputs and inputs may be connected with a Variable Optical Attenuator (VOA).

5. The invention in claim 1 wherein a short piece of fiber optic cable connecting the two ends of a duplex connecter (loop plug) can be inserted into the ports to allow a channel to pass through the ROADM with minimal insertion loss.

6. The invention in claim 1 wherein an optical monitor port can be placed on the common fibers to allow for network troubleshooting and configuration.

7. The invention in claim 1 where the front panels fiber connectors are uniquely configured to allow channel reconfiguration using loop plugs.
